(19) United States
(12) Patent Application Publication
(10) Pub. No.: US 2020/0166108 A1
(43) Pub. Date: May 28, 2020

(54) GEARING ASSEMBLY

(71) Applicant: Philip JENNER, Offham (GB)

(72) Inventor: Philip JENNER, Offham (GB)

(21) Appl. No.: 16/631,978

(22) PCT Filed: Jul. 20, 2018
(86) PCT No.: PCT/GB2018/052062

§ 371 Date: Jan. 17, 2020

(30) Foreign Application Priority Data
Jul. 21, 2017 (GB) 1711757.3

(51) Int. Cl. F16H 35/02; F01C 1/077

(52) U.S. Cl. CPC F16H 35/02; F16H 2035/003; F01C 1/077

(57) ABSTRACT

The present invention relates to a gearing assembly suitable for use with a rotary engine, compressor or pump. Non-circular gears are used to drive rotors at different relative speeds to increase or decrease the volume of a series of chambers and provide the necessary requirements for intake, compression, combustion and exhaust cycles which are typical of an internal combustion engine. The non-circular gears may physically intermesh or be coupled by way of a belt or chain. The relative movement of the rotors can be controlled according to the application by the ratio of the major to minor axis of the non-circular gears. The non-circular gears may be easily removed without having to disassemble the entire gearing system.

The present invention relates to a gearing assembly, in particular though not exclusively for use with a rotary engine, compressor or pump.

Internal combustion engines, such as rotary engines frequently require particular displacement or speed characteristics to drive rotors. Various mechanical systems, such as cams and linkages are often used to provide these motion requirements, but are typically complex, and cannot be compacted into a small area. Their complexity can also make them unreliable.

Noncircular gears such as elliptical or oval gears potentially offer a simpler and more compact solution. Such gears are able to convert a constant input speed into a variable output speed, providing several ‘infinite’ different speed segments during an operating cycle.

The object of the present invention is to provide an improved gearing assembly to effectively control the displacement and speed characteristic of associated components.

According to the present invention there is provided a gearing assembly for controlling rotors within a rotary device, the gearing assembly comprising:—a first shaft having a first rotatable shaft element and a second rotatable shaft element, the first rotatable shaft element being coaxially mounted for relative movement with respect to the second rotatable shaft element; a second shaft whose axis is at least substantially parallel to that of the first shaft; first and second non-circular gears residing on the first shaft, the first non-circular gear being configured to rotate with the first rotatable shaft element and the second non-circular gear being configured to rotate with the second rotatable shaft element; third and fourth non-circular gears residing on the second shaft, the third and fourth non-circular gears being mounted for rotating with the second shaft and being arranged so that their major axes are at fixed at 90° to one another, wherein the first non-circular gear is configured to be coupled with the third non-circular gear and the second non-circular gear is arranged to be coupled with the fourth non-circular gear; and wherein the first rotatable shaft element is coupled to a first rotor and the second rotatable shaft element is coupled to a second rotor, the first and second rotors being co-axially mounted. In this way, the apparatus can provide a compact and simple gearing system to effectively control rotors within a rotary device.

Preferably, the gears have an oval configuration.

Moreover, it will be understood that the term “gear” is intended to encompass gears that physically inter-mesh, as well as sprockets and pulleys that are used together with chains and belts.

Conveniently, a portion of the first and second rotatable shaft elements comprise attachment means for detachably mounting the gears and rotors to the first and second rotatable shaft elements, the attachment means comprising one or more taper lock bushes. The rotors can be easily removed without having to disassemble the entire gearing system. The shafts, rotors and gears may all be detachable and re-attachable to simplify manufacturing and maintenance. Preferably, taper lock bushes and/or ‘reverse’ taper lock bushes may be used to attach any of the shafts, rotors and gears.

Conveniently, the second shaft comprises attachment means for detachably mounting the gears thereto. Similarly, in this way, the timing of the gearing system can be adjusted very easily. For example the gears can be easily removed without having to disassemble the entire gearing system to simplify manufacturing and maintenance. Preferably, taper lock bushes and/or ‘reverse’ taper lock bushes may be used.

Preferably, the second shaft attachment means further comprises a pair of keyseat portions, the arrangement being such that the first portion is positioned substantially perpendicular to the second portion. This enables the gears to be positioned perpendicular to one another.

Preferably, the first rotatable shaft element forms part of an outer section of the first shaft, and the second rotatable shaft element forms part of an inner section of the first shaft. This allows torque to be transferred through the same first shaft and overcomes the need for different shaft arrangements to be used on multiple sides of the rotary device.

Conveniently, the first rotatable shaft element comprises a bore for receiving the second rotatable shaft element therein. This provides a compact arrangement.

Preferably, the attachment means at the first and second rotatable shaft elements comprise a keyseat portion at first ends of the first and second rotatable shaft elements. This may incorporate taper lock bushes and/or reverse taper lock bushes. In this way, the non-circular gears can be securely fixed to the first ends of the first and second rotatable shaft elements.

Conveniently, the attachment means at the first and second rotatable shaft elements comprise a keyseat portion at second ends of the first and second rotatable shaft elements. This enables the rotors to be attached to the second ends of the first and second rotatable shaft elements.

Preferably, the first and second rotors each comprise a respective first piston and a substantially opposing second piston.

Preferably, the first and second pistons each generally take the form of a toroidal section. This provides a piston that ensures efficient sealing and simplified manufacturing.

Conveniently, each of the first and second rotors has a support in the form of hub positioned between respective first and second pistons, the arrangement being such that each hub connects the first and second pistons such that they are positioned substantially opposite each other. This enables the rotors to function in the rotary device.

Preferably, each hub has a substantially curved conical side face. This enables the rotors to sit securely within the rotary device. Also, the majority of the rotors sealing face matches the outer chamber.

Conveniently, the substantially curved conical side face of each hub is complementary to an outer side face of a rotor. This enables the rotors to seat against the hub.

Preferably, each hub has an outer face and an inner face, the arrangement being such that the surface area of the outer face is greater than the surface area of the inner face.

The hubs are preferably, dimensionally substantially the same.

Conveniently, the inner faces of each hub project inwardly to face one another. In this way, the abutted hubs form a bobbin-like member having a concave curved side wall.

Preferably, the peripheral conical side face of the abutted hubs, when aligned forms a continuous concave profile.

Conveniently, the keyseat portions are substantially perpendicular to each other. This provides the necessary timing arrangement for the gearing assembly.

Preferably, the non-circular gears are bi-lobe non-circular gears. Bi-lobe gears provide an accurate gear to provide a variable speed gearing assembly for a rotary device.

Conveniently, the first and second shafts extend through the centre of their associated non-circular gears. This provides for a smooth operation of the gearing assembly.

Preferably, the non-circular gears have a substantially identical tooth profile. This allows each non-circular gear to mesh smoothly with one another.

Conveniently, the non-circular gears have a general length of 100 mm and a general width of 50 mm. This ensures the non-circular gears provide an accurate timing for the rotary device.

Preferably, the ratio of the major to minor axis of the non-circular gears is substantially between 0.43 and 0.72. This ensures the non-circular gears provide an accurate timing for the rotary device.

Conveniently, the ratio of the major to minor axis of the non-circular gears is substantially between 0.50 and 0.64. This ensures the non-circular gears provide an accurate timing for the rotary device.

Preferably, the ratio of the major to minor axis of the non-circular gears is substantially between 037 and 0.58. This ensures the non-circular gears provide an accurate timing for the rotary device.

Conveniently, the ratio of the major to minor axis of the non-circular gears is substantially 0.57446. This ensures the non-circular gears provide an accurate timing for the rotary device.

Preferably, the non-circular gears each have a keyway for attachment to their respective first or second shafts. The keyways may each incorporate taper lock components. This provides for a strong fixing between the gears and the shafts.

Preferably, the gearing assembly is arranged behind one face of a rotary device. This provides a compact gearing assembly, eliminating the need for gears to be provided on both sides of the rotary device.

Preferably, the first non-circular gear is configured to mesh with the third non-circular gear and the second non-circular gear is arranged to mesh with the fourth non-circular gear. In this way, the arrangement is kept as compact as possible.

Alternatively, the first non-circular gear is configured to be coupled with the third non-circular gear by way of a belt or chain. The second non-circular gear may also be arranged to be coupled with the fourth non-circular gear by way of a belt or chain. In this manner, the use of such belts or chains can help to reduce noise, reduce wear and tear of the gear teeth and deal with expansions and contractions of the inter-engaging components. The required manufacturing tolerances for the components can hence be potentially less stringent.

In an alternative embodiment, the first rotatable shaft element and the second rotatable shaft element of the first rotatable shaft are mounted linearly along their shared longitudinal axis. In this configuration, the first and third non-circular gears are behind one face of the rotary device and the second and fourth non-circular gears are in front of the opposite face.

A bearing may be placed between the end of the first rotatable shaft element and the second rotatable shaft element to facilitate their relative movement.

To help understanding of the invention, specific embodiments thereof will now be described by way of example and with reference to the accompanying drawings, in which:—

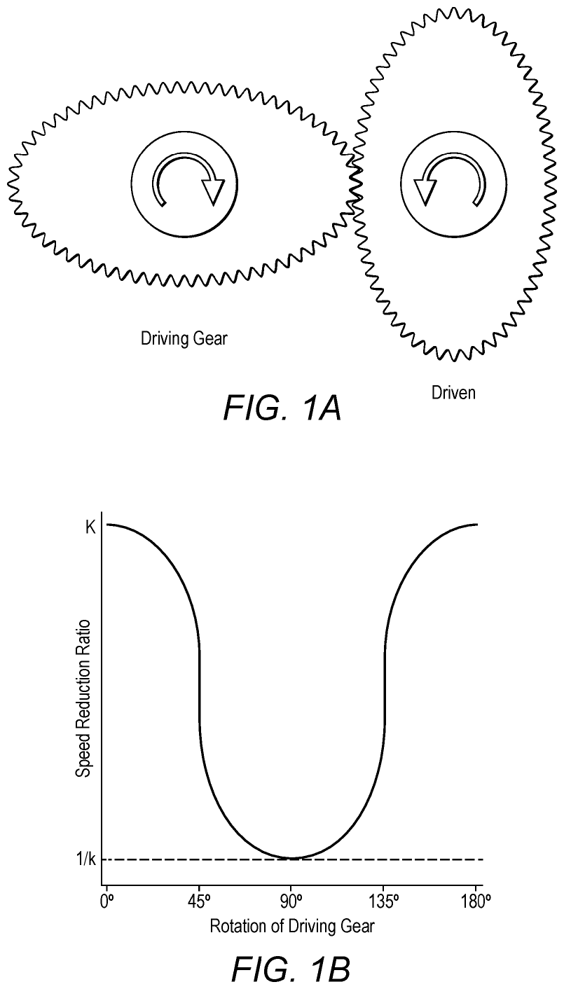

FIG. 1A is a front view of a pair of bi-lobe non-circular gears according to the present invention;

FIG. 1B is a graph showing the relationship of speed reduction ratio and the rotation of the driving gear of the gears shown in FIG. 1;

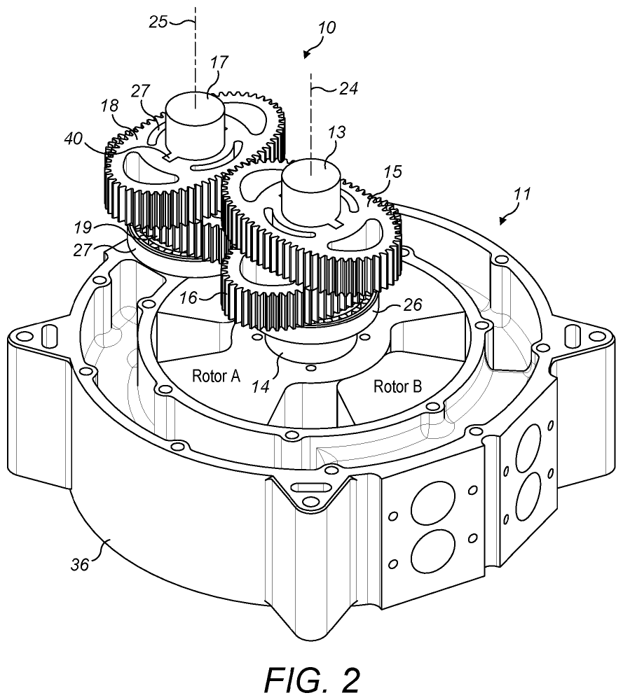

FIG. 2 is a side view of the gearing assembly mounted at the back of a rotary device according to the present invention;

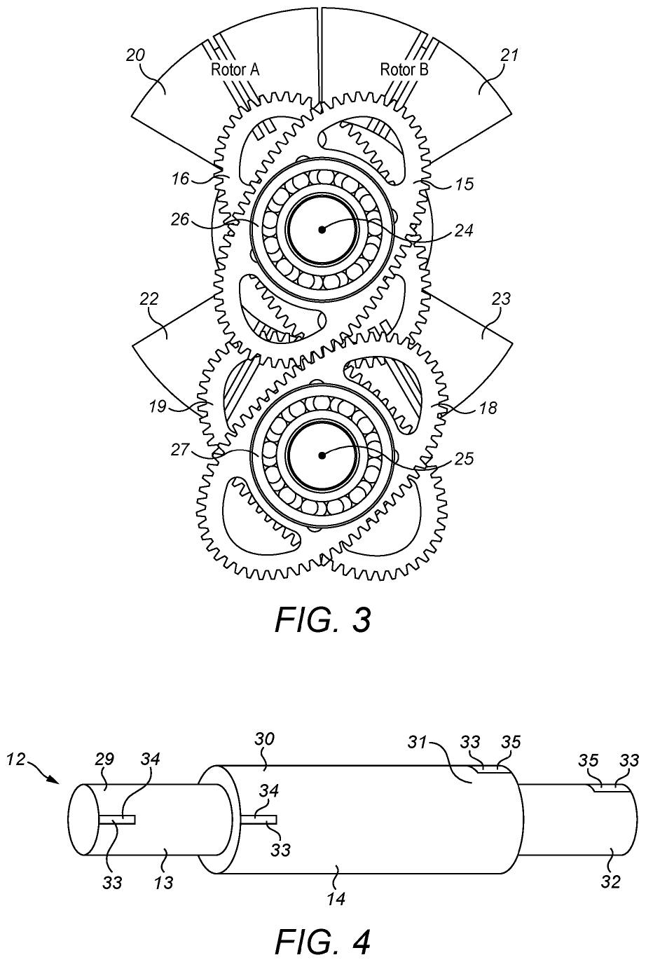

FIG. 3 is a front view of the gearbox assembly according to the present invention;

FIG. 4 is a side view of the output shaft according to the present invention;

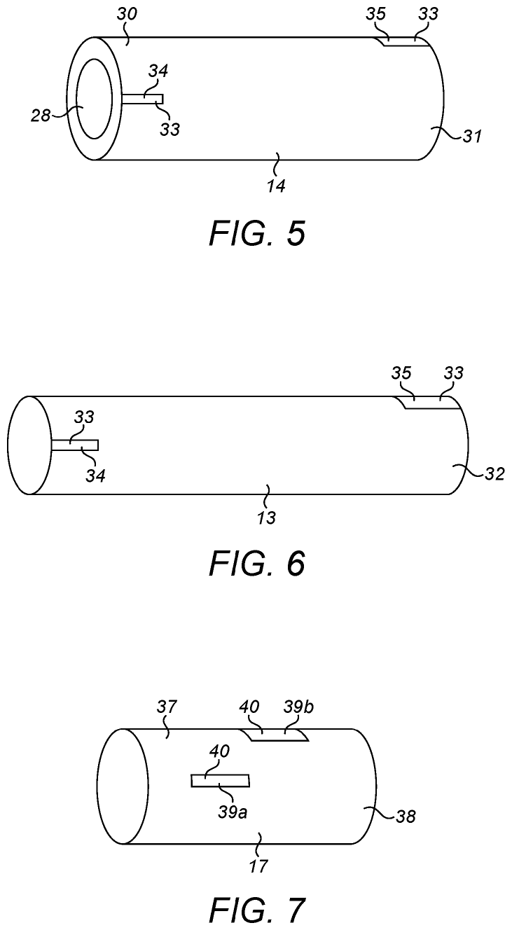

FIG. 5 is view of the first rotatable shaft element according to the present invention;

FIG. 6 is a view of the second rotatable shaft element according to the present invention;

FIG. 7 is a view of the power transfer shaft according to the present invention;

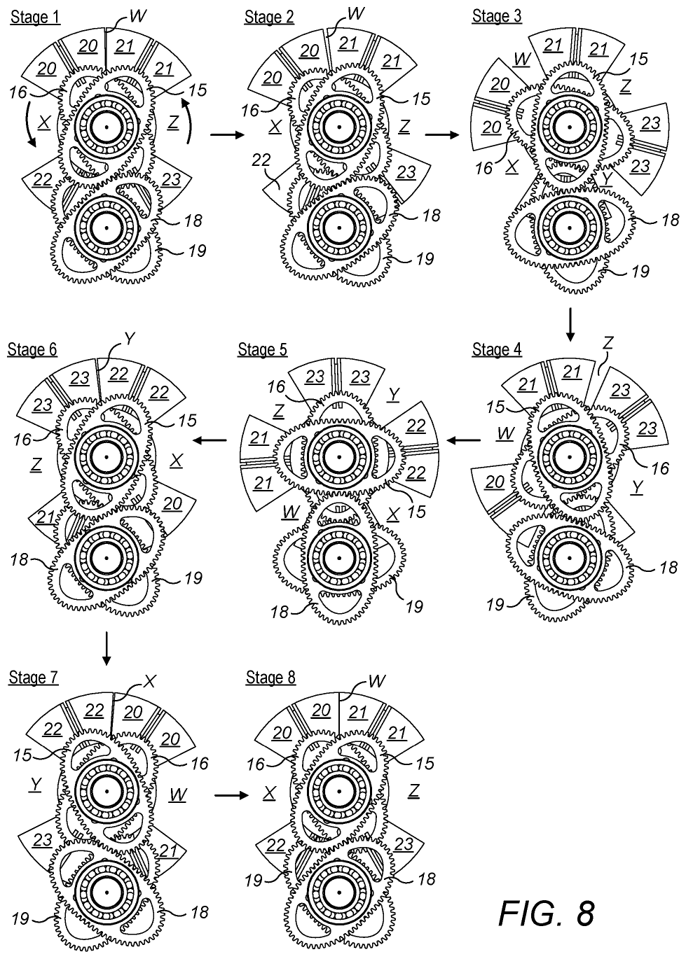

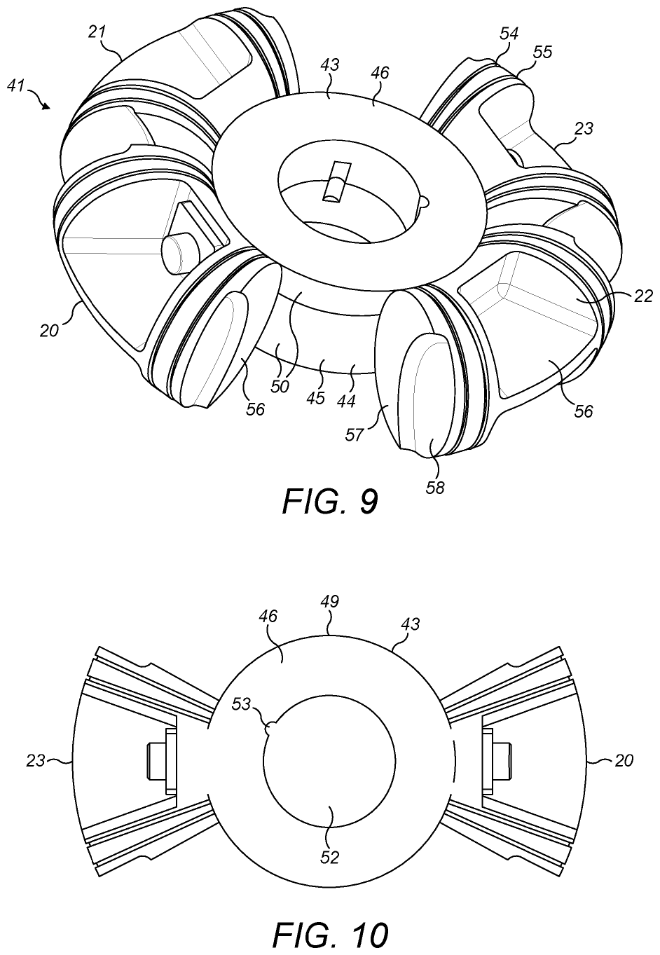

FIG. 8 is a front view of the gearbox assembly according to the present invention showing a timing sequence;

FIG. 9 is a view of a rotor assembly showing the hubs according to the present invention;

FIG. 10 is a plan view of a hub with associated rotor portions showing an outer face;

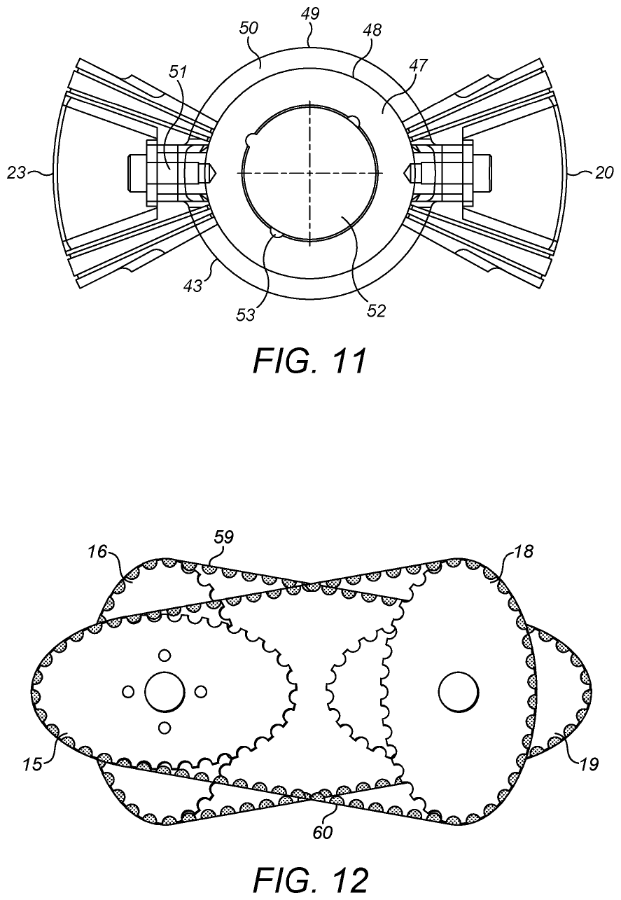

FIG. 11 is a further plan view of hub with associated rotor portions showing an inner face;

FIG. 12 is a view of the non-circular gears connected by way of belts rather than directly intermeshing; and

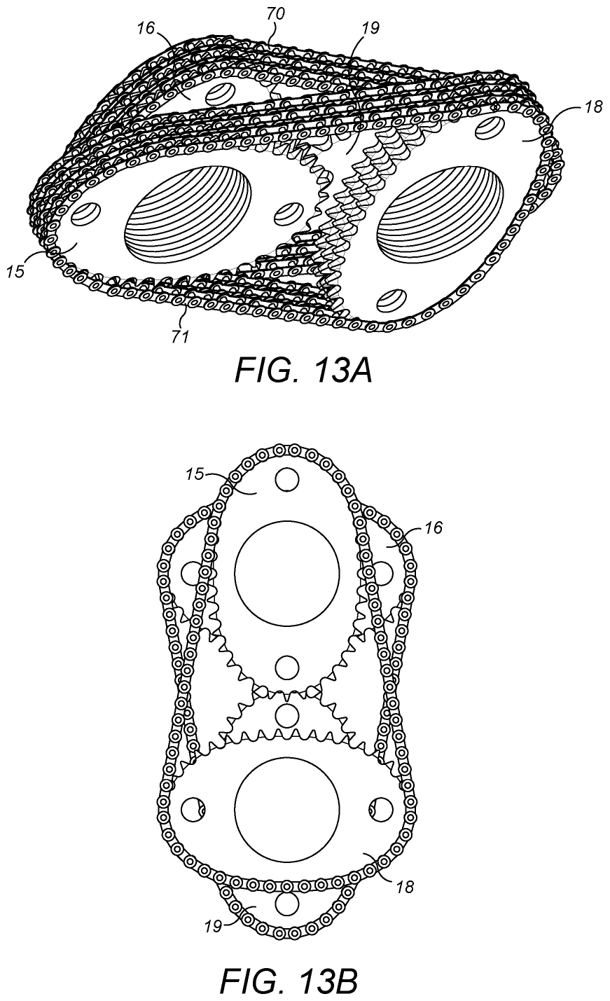

FIGS. 13A and 13B are views of the non-circular gears connected by way of chains rather than directly intermeshing.

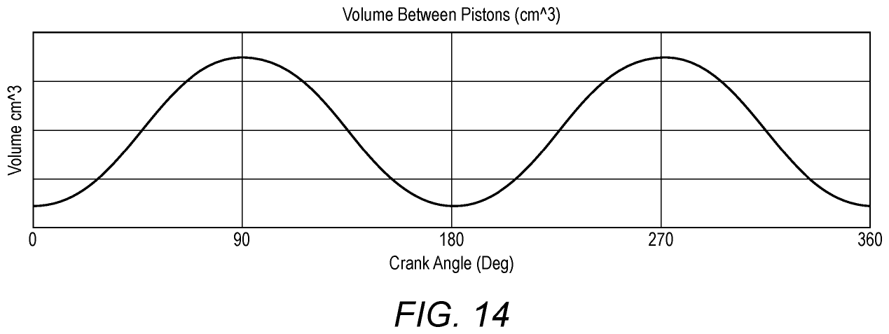

FIG. 14 shows the volume between pistons as the first rotatable shaft element is rotated through 360 degrees in an exemplary rotary engine using the gearing system to provide a timing sequence.

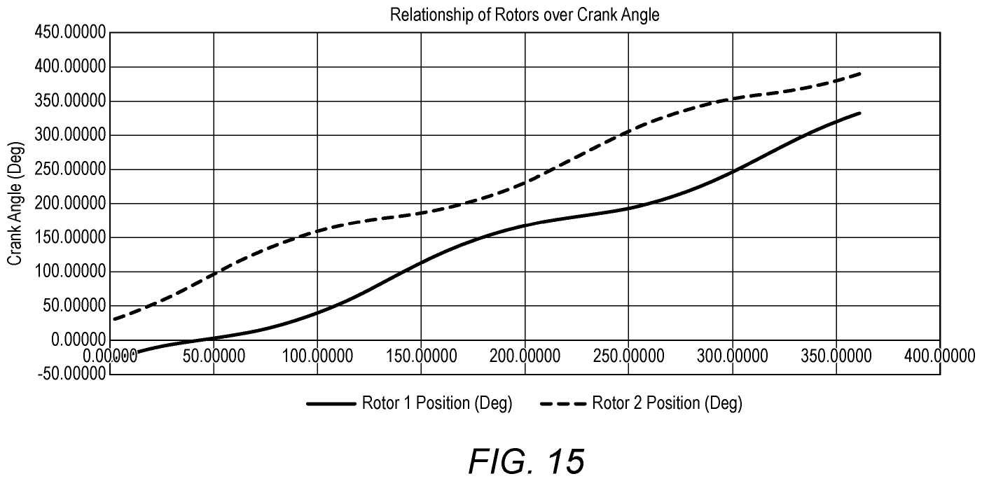

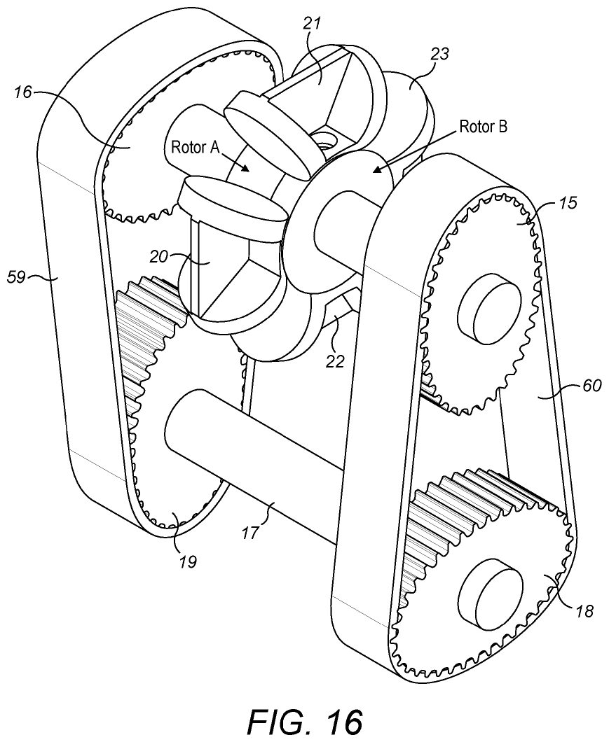

FIG. 15 shows the relationship between the first rotatable shaft element and the second rotatable shaft element in the embodiment of FIG. 14 as the first rotatable shaft is rotated through 360 degrees.

FIG. 16 shows a rotor assembly (without external casing) and alternative arrangement of the first and second rotatable shaft elements.

FIGS. 1A and 1B show a pair of bi-lobe non-circular gears and an associated graph according to the present invention. The speed-reduction (or increasing) ratio of these gears varies from K to 1/K.

With the gears positioned as in FIG. 1A, the largest radius of the driving gear couples with the smallest radius of the driven gear, so that the output speed of the driving gear is at its maximum. As the gears rotate in the direction shown, the radius of the driving gear gradually decreases, and that of the driven gear increases. With respect to the driving gear, speed decreases for the first ¼ revolution, then speed increases for the next ¼ revolution, and so forth. These periods of increasing or decreasing speed occur four times per revolution. In this way the speed of the driven gear can be manipulated to meet requirements. The particular gear profile shown in FIG. 1A has been found to provide advantages in terms of resulting smoothness of rotor movement. In this regard, as shown in FIG. 1B, the graph of speed reduction ratio verses rotation of driving gear angle shows a smooth speed reduction ratio transition through the angular rotation of the driving gear.

Referring to FIGS. 2-7, a gearing assembly 10 is provided for controlling rotors A and B within a rotary device 11. The gearing assembly 10 is mounted at the back of the rotary device 11 and arranged behind one face of the casing 36.

The gearing assembly comprises an output shaft 12 for transferring a torque from the rotary device 11, the output shaft 12 having a first rotatable shaft element 14 and a second rotatable shaft element 13. Non-circular gears 15 and 16 reside on the output shaft 12. The first rotatable shaft element 14 forms part of an outer section of the output shaft 12, and the second rotatable shaft element 13 forms part of an inner section of the output shaft 12.

The first rotatable shaft element 14 comprises a bore or hollow section 28 for receiving the second rotatable shaft element 13 therein. As such, the first rotatable shaft element 14 is of larger diameter than the second rotatable shaft element 13, enabling the second rotatable shaft element 13 to pass through the hollow portion 28 of the first rotatable shaft element 14, to form the output shaft 12. The second rotatable shaft element 13 is generally longer than the first rotatable shaft element 14. Typically, the first rotatable shaft element 14 has a diameter of 50 mm and a length of 115 mm, and the second rotatable shaft element 13 has a diameter of 30 mm and a length of 200 mm.

The first rotatable shaft element 14 and second rotatable shaft element 13 are co-axial, and share the same longitudinal axis 24. In use, the first rotatable shaft element 14 and second rotatable shaft element 13 rotate independently from one another, usually at different speeds. The output shaft 12 extends radially from the rotors A and B, and runs through a gear assembly casing (not shown). As such, the output shaft 12 is supported by bearings 26 which are pressed into the casing, and are typically a ball or tapered roller-type bearing. Additionally, a bearing or several bearings (not shown) is/are captivated between the first rotatable shaft element 14 and second rotatable shaft element 13. These are typically in the form of a white metal bearing shell generally used to support a crankshaft in an internal combustion engine. Such an arrangement helps to reduce wear occurring between the first rotatable shaft element 14 and second rotatable shaft element 13.

As shown in FIG. 4, a portion of the first (29 and 30) and second (31 and 32) ends of the first and second rotatable shaft elements 14 and 13 comprise attachment means 33 to detachably fix the gears 15 and 16 and rotors A and B to the first and second rotatable shaft elements 14 and 13. The attachment means 33 at first ends (29 and 30) of the first and second rotatable shaft elements 14 and 13 comprise a keyseat portion 34, and are not adjustable with respect to the gears 15 and 16. The keyseat portions 34 have a length of 25 mm, width of 8 mm and a depth of 4 mm. The attachment means 33 at the second ends (31 and 32) of the first and second rotatable shaft elements 14 and 13 are also not adjustable with respect to the rotors A and B. The attachment 33 means at the second ends (31 and 32) of the first and second rotatable shaft elements 14 and 13 comprise a keyseat portion 35. The keyseat portions 34 have a length of 25 mm, width of 8 mm and a depth of 4 mm. As shown, keyseat portions 34 and 35 are generally positioned at substantially 90° to each other.

Spaced adjacent the output shaft 12 is a power transfer shaft 17 having a longitudinal axis 25. The power transfer shaft is arranged to receive a torque from the output shaft 12. As shown, one or more non-circular gears 18, 19 reside on the power transfer shaft. As such, the one or more of the non-circular gears 15, 16 residing on the output shaft 12 mesh with the one or more non-circular gears 18, 19 residing on the power transfer shaft 17. The output shaft 12 and power transfer shaft 17 extend through the centre of the non-circular gears.

The axis of the output shaft 12 and power transfer shafts 17 are substantially parallel. The power transfer shaft 17 has a diameter of 30 mm and a length of 100 mm. The power transfer shaft 17 is secured in a casing (not shown) and is supported by rear and forward bearings 27. Bearings 27 are pressed into the casing, and are typically a bail or tapered roller-type bearing.

As shown in FIG. 7, first 37 and second 38 ends of the power transfer shaft 17 comprise keyseat portions 39a and 39b. The first keyseat portion 39a is positioned substantially perpendicular to the second keyseat portion 39b. The portions 39a and 39b are somewhat offset from the end edges of the first and second ends of the power transfer shaft, and generally arranged in the middle of shaft 17. This arrangement allows for a portion of shaft 17 to project outwardly from gears 18 and 19, allowing for power take off (e.g. attachment of a pulley to shaft 17). Each keyseat portion 39a and 39b has a length of 25 mm, a width of 8 mm and a depth of 4 mm. Due to the perpendicular orientation of the key-seat portions 39 on the power transfer shaft 17, the third 18 and fourth 19 gears are arranged such that their major axis are fixed at 90° to one another.

The non-circular gears 15, 16, 19 and 18 are bi-lobe non-circular gears and, as shown in FIG. 8, provide the necessary timing requirements for the rotary assembly 11. The gears 15, 16, 19 and 18 are constructed from steel or aluminium, but alternative materials such as plastics or composites may be suitable in certain circumstances.

The non-circular gears 15, 16, 19 and 18 have an identical tooth profile. Non-circular gears 15, 16, 19 and 18 have a general length of substantially 100 mm and a general width of substantially 50 mm. The ratio of the major to minor axis of each non-circular gear is substantially between 0.43 and 0.72. More preferably, substantially between 0.50 and 0.64, yet more preferably, substantially between 0.57 and 0.58, and in a preferred embodiment the ratio is substantially 0.57446. In the embodiment shown in FIG. 1A, each gear has 62 teeth distributed around its circumference.

Referring back to FIG. 2, the non-circular gears comprise keyways 40 for attachment to the output 12 and power shaft 17. Means to fix the gears 15 and 16 to the first and second rotatable shaft elements 13, 14 are by a keyed joint by means of taper lock bushes and/or reverse taper lock bushes. Gears 15 and 16 comprise keyways 40 having a width of 8 mm and a depth of 4 mm which are machined into the key-shaft holes. Keys are positioned between the key-seats 34 and keyways 40. The keys are preferably 25 mm in length, 8 mm in height and 8 mm in width.

Similarly, a keyed joint fixes the third and fourth gears to the power transfer shaft 17 by means of taper lock bushes and/or reverse taper lock bushes. In this respect, third 19 and fourth 18 gears comprise keyways 40 which are machined into the keyed shaft holes having a width of 8 mm and a depth of 4 mm. Captured between the key-seats 39 and keyways 40 are keys. The keys are preferably 25 mm in length, 8 mm in height and 8 mm in width.

To compensate for the different sizes of shaft elements 13 and 14, first gear 15 has a key-shaft hole diameter of 30.1 mm, and second gear 16 has a key-shaft hole diameter of 45.1 mm. Both third gear 18 and fourth gear 19 have key-shaft hole diameters of 30.1 mm for coupling to the power transfer shaft 17.

In an alternative gear attachment arrangement, the gears 15, 16, 18 and 19 each comprise a shaft hole, devoid of a keyway machined therein. In this regard, taper lock bushes are driven into the shaft holes and additional apertures, threaded or un-threaded may be machined in the shaft holes which may fully or partially extend through the thickness. Together with bolts or screws this provides additional securing means for the taper lock bushes. The taper lock bushes each comprise a key-shaft hole to secure the gears 15, 16, 18 and 19 to the respective shaft 12, 13, 14, 17.

The first rotatable shaft element 14 is coupled to a second gear 16, the second shaft rotatable element 13 is coupled to a first gear 15 and the power transfer shaft 17 is coupled to a third 18 and fourth 19 gear. The first gear 15 intermeshes with the third gear 18 and the second gear 16 intermeshes with the fourth gear 19.

As shown in FIGS. 3 and 8-11, first rotor A is formed of a top portion 20, and respective bottom portion 23. Similarly, second rotor B is formed of a top portion 21 and a bottom portion 22.

In one embodiment shown in FIGS. 9-11, the rotor assembly 41 is comprised of rotor portions, in the form of pistons, 20, 21, 22 and 23 that take the form of a toroidal section.

Each piston 20, 21, 22, 23 comprises grooves 54, 55 to accommodate piston rings providing sealing means for the rotor assembly 41. Swirl chambers 58, are provided to piston outer end faces 56, 57 and the pistons comprise cut-outs 56 to reduce weight.

Each of the first and second rotors A, B has an annular support, in the form of a hub 43, 44 positioned between respective first 20 and 21 and second 23 and 22 rotor portions. Each hub 43, 44 connects the first 20 and 21 and second 23 and 22 pistons such that they are positioned substantially opposite each other.

FIGS. 10 and 11 show hub 43 connected to pistons 20 and 23 in further detail. Whilst hub 43 is shown explicitly, hub 44 shown in FIG. 9 connected to pistons 21 and 22 has the same features.

As shown, each hub 43, 44 has a substantially conical shaped peripheral side face 50 provided between the edge 49 of the outer face 46 and the edge 48 of the inner face 47.

The conical peripheral side face 50 is complementary to an outer face of pistons 20, 21, 22 and 23. In this regard, the pistons 20, 21, 22 and 23 seat against the conical peripheral face 50 of the respective hub 43, 44. The pistons 20, 21, 22, 23 are secured to their respective hub 43, 44 preferably by a fixing such as a bolt 51. Optionally, a threaded aperture is provided through the pistons 20, 21, 22, 23 and the corresponding hub 43, 44. Optionally, the pistons 20, 21, 22, 23 may be welded to the relevant hub 43, 44.

Each hub 43, 44 has an outer face 46 and an inner face 47, the inner faces 47 facing each other when the hub 43, 44 are stacked upon one another. The surface area of the outer face 46 of the hub is generally larger than the surface area of the inner face 47 of the hub.

Provided through the centre of each hub 43, 44 and with respect to the faces 46, 47 is a perpendicular bore forming a central tapered hole 52, optionally arranged to accept a taper lock bush and/or a reverse taper lock bush. Taper lock bushes and/or reverse taper lock bushes are usually driven into the hole 52 of each support 43, 44, and optionally, cut out portions 53, threaded or un-threaded may be machined around the periphery of the hole 52 which may fully or partially extend through the thickness of the hole 52. Together with bolts or screws driven through cut out portions 53, this arrangement provides additional securing means for the taper lock bush and/or reverse taper lock bush. The taper lock bushes (not shown) comprise a key-shaft hole to secure the rotor assembly to the respective shaft portions 13, 14.

As shown in FIG. 9 and FIG. 11, the annular supports, in the form of hubs 43, 44 seat against each other such that the inner face 47 of the hub 43 seats against the inner face 47 of the hub 44. In this connection, the inner face 47 of each hub 43, 44 projects inwardly, toward each other, and the outer face 46 of each hub 43, 44 projects outwardly, away from each other. As shown, the pistons 20, 21, 22, 23 are accommodated by the peripheral side face 50 provided by each hub 43, 44, such that, when aligned together, the conical peripheral side faces 50 of each hub 43, 44 form a concave profile 45. Since each hub 43, 44 is connected to the respect shaft portions 13, 14, each rotor A, B, comprised of the respective hub 43, 44 and piston 20, 21, 22, 23, together form the complete rotor assembly 41.

In the arrangement shown in FIG. 9, pistons 20, 21, 22 and 23 preferably have a diameter of 270 mm, a radius of 135 mm, and a rotor face diameter of 80 mm.

Turning back to FIG. 8, a timing sequence of the gearing assembly 10 is shown. At stages 1 through to 8, rotors A and B move at different speeds, due to the non-circular shape of the gears, the speed decreasing for the first % revolution, and increasing for the next ¼ revolution. Providing that the timing of the two rotors A and B is out of phase, i.e. one rotor is speeding up whilst the other rotor is slowing down, this allows for the formation of a series of chambers W, X, Y and Z that change in volume throughout a single revolution of the output shaft 12 (which forms both the first rotatable shaft element 14 and the second rotatable shaft element 13). In other words, chambers W, X, Y and Z are variable volume chambers, and thus the gearing assembly can provide the necessary timing for these chambers to occur. Due to this variation in volume, this provides the necessary requirements for intake, compression, combustion and exhaust cycles which are typical of an internal combustion engine.

At stage 1, referred to herein as top dead centre (TDC) with respect to chamber W, beginning with the first rotatable shaft element 14, (i.e. the outer section of the output shaft 12) during rotation of the first rotatable shaft element 14 about rotation axis 24, gear 16 moves in rotational movement, and rotates about rotation axis 24, moving rotor A, formed of portions 20 and 23. During its rotational movement, gear 16 meshes with gear 19 and causes power transfer shaft 17 to rotate about rotation axis 25.

Moving to the second rotatable shaft element 13, (i.e. the inner section of the output shaft 12) during rotation about rotation axis 24, during rotation of the second rotatable shaft element 13, gear 15 moves in rotational movement, and rotates about rotation axis 24, moving rotor B, formed of portions 21 and 22. During its rotational movement, gear 15 meshes with gear 18 and causes power transfer shaft 17 to rotate about rotation axis 25.

With respect to each of the chambers W, X, Y, and Z, each chamber moves through the following stages during one complete revolution of the output shaft 12:—

Stage 1:

Chamber W—Ignition stroke. Chamber W is shown at top dead centre (TDC). Ignition can occur at TDC, slightly before TDC, i.e. (BTDC) retarded timing, or slightly after TDC, i.e. (ATDC) advanced timing. Prior to ignition, the fuel/air mixture has been compressed.

Chamber X—Power/expansion stoke. Expansion of gases from the fuel/air mixture causes transfer of chemical energy into useful mechanical energy. That is, the expansion force applied to rotor B through portion 22 is output as a torque through second rotatable shaft element 13.

Chamber Y—Exhaust stroke. Although not easily seen, as the chamber reduces in volume from a power stroke, exhaust is vented out through an exhaust port. As the chamber increases in size, a fuel/air mixture is drawn in through an inlet port by a vacuum created as the chamber increases in size.

Chamber Z—Induction/compression stoke. The fuel air/mixture is compressed prior to ignition.

Stage 2:

Chamber W—Ignition stroke. Chamber W is shown advance of TDC.

Chamber X—Power/expansion stroke. An explosion expansion force is applied to rotor B through portion 22 and is output as a torque through second rotatable shaft element 13.

Chamber Y—Exhaust stroke. Exhaust is vented out through an exhaust port, and fuel/air mixture drawn in through an inlet port.

Chamber Z—Induction/compression stroke. The fuel air/mixture is compressed prior to ignition.

Stage 3:

Chamber W—Power/expansion stroke (mid). An explosion expansion force is applied to rotor A through portion 20 and is output as a torque through first rotatable shaft element 14.

Chamber X—Power/expansion stroke (mid). An explosion expansion force is applied to rotor B through portion 22 and is output as a torque through second rotatable shaft element 13.

Chamber Y—Induction (mid). The fuel air/mixture is compressed prior to ignition.

Chamber Z—Compression stroke (mid). The fuel air/mixture is compressed prior to ignition.

Stage 4:

Chamber W—Power/expansion stroke. An explosion expansion force is applied to rotor A through portion 20 and is output as a torque through first rotatable shaft element 14.

Chamber X—Exhaust stroke. Exhaust is vented out through an exhaust port, and fuel/air mixture drawn in through an inlet port.

Chamber Y—Induction. The fuel air/mixture is compressed prior to ignition.

Chamber Z—Compression stroke (end). The fuel air/mixture is compressed prior to ignition.

Stage 5:

Chamber W—Power/expansion stroke (mid). An explosion expansion force is applied to rotor A through portion 20 and is output as a torque through first rotatable shaft element 14.

Chamber X—Induction (mid). The fuel air/mixture is compressed prior to ignition.

Chamber—Induction/compression stroke (mid). The fuel air/mixture is compressed prior to ignition.

Chamber Z—Power/expansion stroke (start). An explosion expansion force is applied to rotor B through portion 21 and is output as a torque through second rotatable shaft element 13.

Stage 6:

Chamber W—Exhaust stroke. Exhaust is vented out through an exhaust port, and fuel/air mixture drawn in through an inlet port.

Chamber X—Induction/compression stroke. The fuel air/mixture is compressed prior to ignition.

Chamber Y—Ignition stroke. Chamber Y is shown advance of TDC.

Chamber Z—Power/expansion stroke. An explosion expansion force is applied to rotor B through portion 21 and is output as a torque through second rotatable shaft element 13.

Stage 7:

Chamber W—Induction/compression stroke. The fuel air/mixture is compressed prior to ignition.

Chamber X—Ignition stroke. Chamber X is shown before TDC.

Chamber Y—Power/expansion stroke. An explosion expansion force is applied to rotor A through portion 23 and is output as a torque through first rotatable shaft element 14.

Chamber Z—Exhaust stroke. Exhaust is vented out through an exhaust port, and fuel/air mixture drawn in through an inlet port.

Stage 8 (same as stage 1):

Chamber W—Ignition stroke. Chamber W is shown at TDC.

Chamber X—Power/expansion stroke. Power/expansion stroke. An explosion expansion force is applied to rotor B through portion 22 and is output as a torque through second rotatable shaft element 13.

Chamber Y—Exhaust stroke. Exhaust is vented out through an exhaust port, and fuel/air mixture drawn in through an inlet port.

Chamber Z—Induction/compression stroke. The fuel air/mixture is compressed prior to ignition.

FIG. 12 shows an alternative arrangement for coupling the gears (pulleys/sprockets) 15 and 18 and 16 and 19. In this respect, rather than the gears meshing directly, belts 59 and 60 are used to couple the gears together. This can have advantages in terms of reducing operating noise, reducing wear and tear at the teeth, and in potentially relaxing the manufacturing tolerances required.

FIG. 13 shows a further alternative arrangement for coupling the gears (pulleys/sprockets) 15 and 18 and 16 and 19. In this respect, rather than the gears meshing directly, chains 70 and 71 are used to couple the gears together. This can have advantages in terms of reducing operating noise, reducing wear and tear at the teeth, and in potentially relaxing the manufacturing tolerances required.

FIG. 14 shows the volume between two pistons in a rotary engine using the gearing assembly to provide a timing sequence. As the first rotatable shaft element 14 is rotated, the relative motion of the hub 43 on the first rotatable shaft element 14 and the hub 44 on the second rotatable shaft element 13 causes the volume of the chambers between the pistons to vary. When chambers X and Z are at their maximum volume, chambers W and Y are at their minimum volume. In a preferred embodiment, the chamber volume varies in a sinusoidal manner as shown, although the precise variation is dependent on the shape of the non-circular gears.

FIG. 15 shows the relationship of “rotors over crank angle” in a preferred embodiment of a rotary engine using the gearing assembly. As can be seen, the rotors move apart for the first quarter revolution then together for the next quarter revolution and so forth.

FIG. 16 shows a rotor assembly, which could be used in a rotary internal combustion engine coupled to an alternative embodiment of the gearing assembly. In this embodiment, rotor B is coupled to first gear 15 via first rotatable shaft element and rotor A is coupled to second gear 16 by second rotatable shaft element. In this configuration, first and third gears are on one side of the rotary device and second and fourth gears are on the opposite side of the rotary device. First rotatable shaft elements can rotate at a different speed to second rotatable shaft element to allow appropriate relative movement of the pistons 20, 21, 22, 23 as described previously. First gear (or pulley) 15 is coupled to third gear (or pulley) 18 by a belt 60. Second gear (or pulley) 16 is coupled to fourth gear (or pulley) 19 via a belt 59. Depending on the application, the belts 59, 60 may have teeth to prevent them slipping on the pulleys. Third gear (or pulley) 18 is coupled to fourth gear (or pulley) 19 by second shaft 17.

1. A gearing assembly for controlling rotors within a rotary device, the gearing assembly comprising:—
a first shaft having a first rotatable shaft element and a second rotatable shaft element, the first rotatable shaft element being coaxially mounted for relative movement with respect to the second rotatable shaft element;
a second shaft whose axis is at least substantially parallel to that of the first shaft;
first and second non-circular gears residing on the first shaft, the first non-circular gear being configured to rotate with the first rotatable shaft element and the second non-circular gear being configured to rotate with the second rotatable shaft element;
third and fourth non-circular gears residing on the second shaft, the third and fourth non-circular gears being mounted for rotating with the second shaft and being arranged so that their major axes are at fixed at 90° to one another;
wherein the first non-circular gear is configured to be coupled with the third non-circular gear and the second non-circular gear is arranged to be coupled with the fourth non-circular gear; and
wherein the first rotatable shaft element is coupled to a first rotor and the second rotatable shaft element is coupled to a second rotor, the first and second rotors being co-axially mounted.

2. A gearing assembly according to claim 1, wherein a portion of the first and second rotatable shaft elements comprise attachment means for detachably mounting the gears and rotors to the first and second rotatable shaft elements, the attachment means comprising one or more taper lock bushes.

3. A gearing assembly according to claim 2, wherein the second shaft comprises attachment means for detachably mounting the gears thereto, and wherein the second shaft attachment means further comprises a pair of keyseat portions, the arrangement being such that the first portion is positioned substantially perpendicular to the second portion.

4. (canceled)

5. A gearing assembly according to claim 2, wherein the first rotatable shaft element forms part of an outer section of the first shaft, and the second rotatable shaft element forms part of an inner section of the first shaft.

6. (canceled)

7. A gearing assembly according to claim 2, wherein the attachment means at the first and second rotatable shaft elements comprise a keyseat portion at first ends of the first and second rotatable shaft elements.

8. A gearing assembly according to claim 2, wherein the attachment means at the first and second rotatable shaft elements comprise a keyseat portion at second ends of the first and second rotatable shaft elements.

9. A gearing assembly according to claim 1, wherein the first and second rotors each comprise a respective first piston and a substantially opposing second piston.

10. A gearing assembly according to claim 9, wherein the first and second pistons each generally take the form of a toroidal section.

11. A gearing assembly according to claim 9, wherein each of the first and second rotors has a support in the form of a hub positioned between respective first and second pistons, the arrangement being such that each hub connects the first and second pistons such that they are positioned substantially opposite each other.

12. A gearing assembly according to claim 11, wherein each hub has a substantially curved conical side face.

13. A gearing assembly according to claim 12, wherein the substantially curved conical side face of each hub is complementary to an outer side face of a piston.

14. A gearing assembly according to claim 11, wherein each hub has an outer face and an inner face, the arrangement being such that the surface area of the outer face is greater than the surface area of the inner face.

15. A gearing assembly according to claim 14, wherein the inner faces of each hub project inwardly to face one another.

16. A gearing assembly according to claim 12, wherein the conical side face of the abutted hubs when aligned forms a continuous concave profile.

17. (canceled)

18. A gearing assembly according to claim 1, wherein the non-circular gears are bi-lobe non-circular gears.

19. A gearing assembly according to claim 1, wherein the first and second shafts extend through the centre of their associated non-circular gears.

20. (canceled)

21. (canceled)

22. (canceled)

23. A gearing assembly according to claim 1, wherein the ratio of the major to minor axis of the non-circular gears is substantially between 0.50 and 0.64, preferably substantially between 0.57 and 0.58.

24. (canceled)

25. (canceled)

26. A gearing assembly according to claim 1, wherein the non-circular gears each have a keyway for attachment to their respective first or second shafts.

27. A gearing assembly according to claim 1, wherein the gearing assembly is arranged behind one face of a rotary device.

28. (canceled)

29. (canceled)

30. (canceled)
